(19) United States
(12) Patent Application Publication
(10) Pub. No.: US 2013/0262178 A1
(43) Pub. Date: Oct. 3, 2013

(54) SYSTEM, METHOD, AND INTERFACE FOR EVALUATING A LEAD

(71) Applicants: James Schronrock, Blaine, MN (US); Elle Mason, St. Paul, MN (US)

(72) Inventors: James Schronrock, Blaine, MN (US); Elle Mason, St. Paul, MN (US)

(21) Appl. No.: 13/435,812

(22) Filed: Mar. 30, 2012

(51) Int. Cl. G06Q 50/18

(52) U.S. Cl. CPC G06Q 50/18; G06Q 30/0201
USPC 705/7.29

(57) ABSTRACT

A method includes receiving a set of lead information. The method also includes generating a case evaluation associated with the set of lead information and retrieving a set of additional information associated with the set of lead information. Furthermore, the method includes generating and transmitting a display signal associated with the set of lead information, the case evaluation and the set of additional information. Another embodiment includes analyzing one or more of the set of lead information, the case evaluation and the set of additional information. Another embodiment includes notifying a professional when a set of criteria is satisfied, the set of criteria associated with meeting or exceeding a threshold for at least one of the set of lead information, the case evaluation and the set of additional information.

### COPYRIGHT NOTICE AND PERMISSION

A portion of this patent document contains material subject to copyright protection. The copyright owner has no objection to the facsimile reproduction by anyone of the patent document or the patent disclosure, as it appears in the Patent and Trademark Office patent files or records, but otherwise reserves all copyrights whatsoever. The following notice applies to this document: Copyright © 2011 Thomson Reuters.

### TECHNICAL FIELD

Various embodiments of the present invention concern system, method and interface for evaluating a lead.

### BACKGROUND

Professionals today are tasked with not only performing the duties within their job description but also frequently must bring in additional revenue for a company/firm. For example, a lawyer may have current clients for which he does product liability litigation. His daily job description includes drafting briefs, memorandums, motions, emails and communicating with current clients. Yet, as the lawyer is promoted within the firm, the responsibility of bringing in clientele increases. Responsibilities may include networking, communicating via social media, and/or advertising to bring in leads that may become clients. A lead is an individual or organization that expresses interest in a firm's goods or services. However, besides the lawyer's personal experience, he has no other efficient way of assessing the leads he receives through the aforementioned examples. In another example, if the lawyer is a solo practioner, the sole responsibility to manage leads for his firm may become cumbersome. The solo lawyer may have to keep track of the number of leads, the number of times his website is visited, the number of times his firm and/or key words are searched using a search engine, and/or the number of people who view videos and/or electronic advertising materials. Keeping track of these metrics may assist the solo practioner in addressing weaknesses within his revenue building strategy.

A significant obstacle encountered by large law firms and solo practioners alike is how to determine if a lead has enough potential to be profitable. In order to make that determination, professionals need various sets of information to determine if this lead is worth pursuing. One known approach to managing leads is a lead management system. For example, John, a solo criminal practice attorney, has a lead management system that allows him to input lead information about each retained client. In addition, if a lead calls in, he may input the initial information into this system. The lead management system may also include a section where the initial contact type and follow up contacts are inputted. However, this lead management system fails to provide John any additional information about a lead. For example, Sally, an incoming lead, may send a brief email stating she is charged with a driving while intoxicated offense. She leaves her name, address and phone number. The lead management system may be able to store this information. However, the system does not assess the quality of the lead. For instance, there is no case evaluation and/or additional information to help John determine if this lead is potentially profitable.

To date, lead management systems have not provided information to determine the quality of the lead. However, for professionals that require efficiency and quality, a better solution is needed.

### SUMMARY

The inventors have recognized the necessity for additional improvements in evaluating a lead. In particular, the present invention allows for evaluating a lead by receiving a set of lead information. Consequently, the set of lead information is associated with generating a case evaluation and retrieving a set of additional information. For example, a lawyer may receive a set of initial lead information such as a name, address and phone number from a lead. The set of lead information may then be used to generate a case evaluation to better assess the quality of the legal case. The case evaluation may include information about the average case award for this case type, the percentage of cases settled and/or won by plaintiff or defendant and/or the last case award amount. The set of lead information may also be used to retrieve a set of additional information to better assess the quality of the case. For example, the set of additional information may include U.S. Census Bureau information, a range of household income and/or home values based on the address provided.

Advantageously, the present invention permits notifying a professional when a set of criteria is satisfied. Continuing from the previous example, the lawyer may provide a set of criteria regarding when to be notified of a lead. This set of criteria may be based on case type, average case award, percentage of plaintiff wins, etc. Once this set of criteria is satisfied, the professional may then be notified, for example, by email. In addition to the advantages explained earlier, the notification process allows the lawyer to further filter and determine which cases have the best potential considering the lawyer's customized criteria.

Additional advantages and/or features of the present invention will be set forth in part in the description. It is to be understood that both the foregoing general description and the following detailed description of the present invention are exemplary and explanatory and are intended to provide further explanation of the present invention as claimed.

### BRIEF DESCRIPTION OF THE DRAWINGS

FIG. 1 is an exemplary system 100 which corresponds to one or more embodiments of the invention.

FIG. 1A is a more detailed view of the lead evaluation module 140 of FIG. 1 which corresponds to one or more embodiments of the invention.

FIG. 2 is an exemplary method 200 which corresponds to one or more embodiments of the invention.

FIG. 3 is an exemplary interface 300 which corresponds to one or more embodiments of the invention.

### DETAILED DESCRIPTION OF THE EXEMPLARY EMBODIMENT(S)

### Exemplary Document Processing and Information Retrieval System

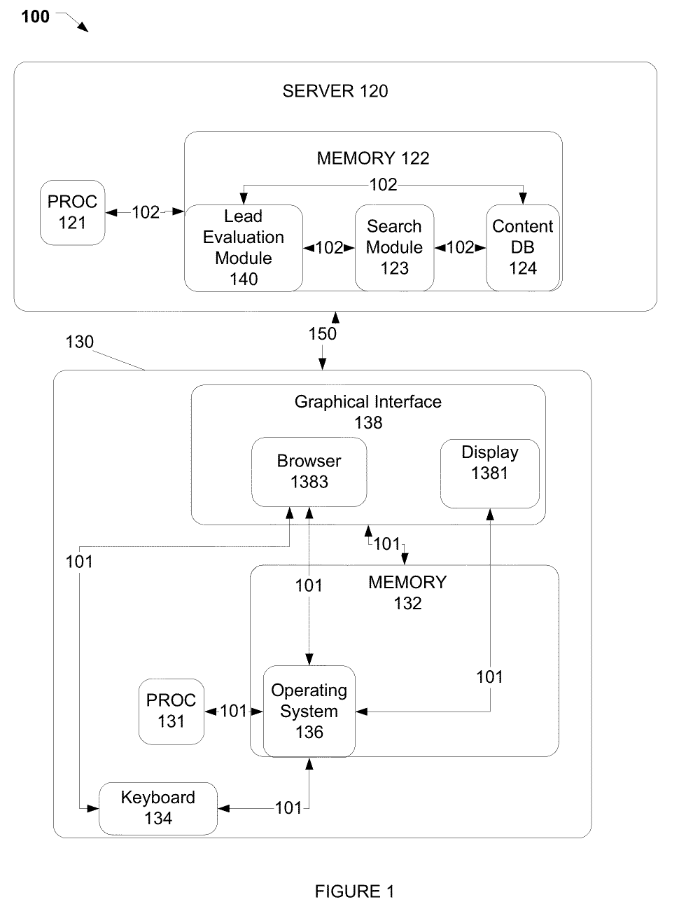

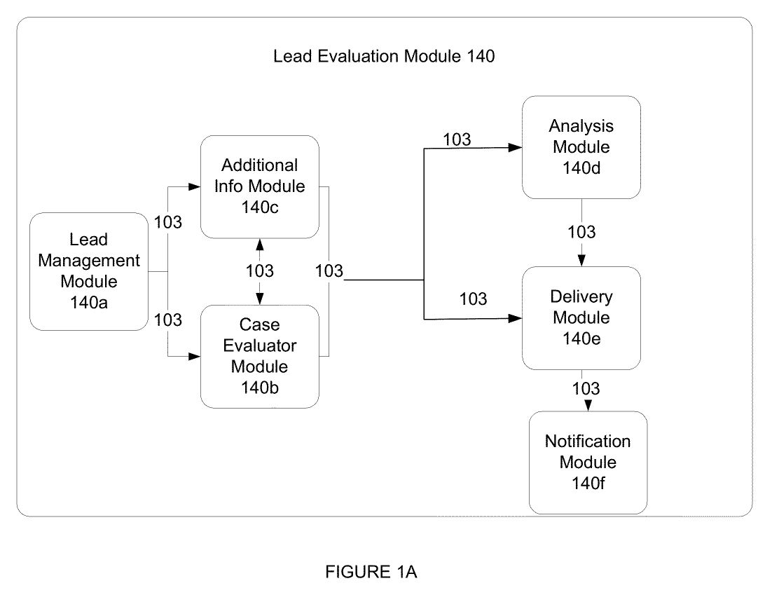

FIG. 1 shows an exemplary system 100, which may be adapted to incorporate the capabilities, functions, methods, and interfaces of the present invention. FIG. 1A further shows exemplary lead evaluation module 140, which may be adapted to incorporate into system 100. System 100 includes a server 120 and an access device 130.

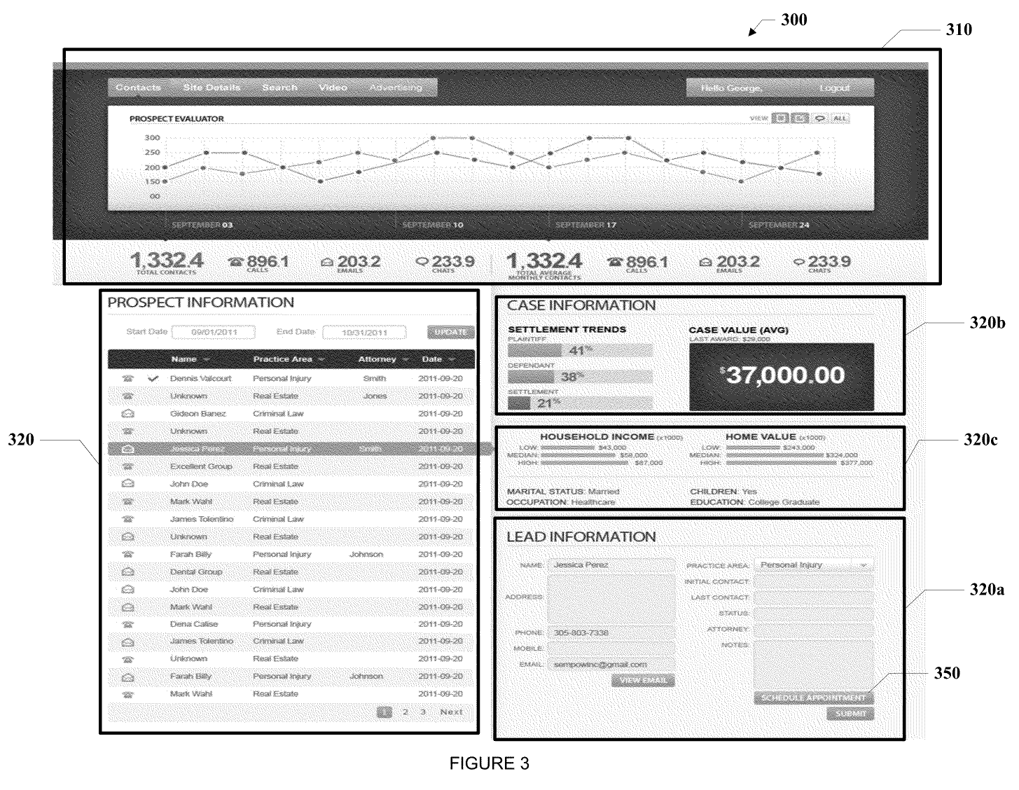

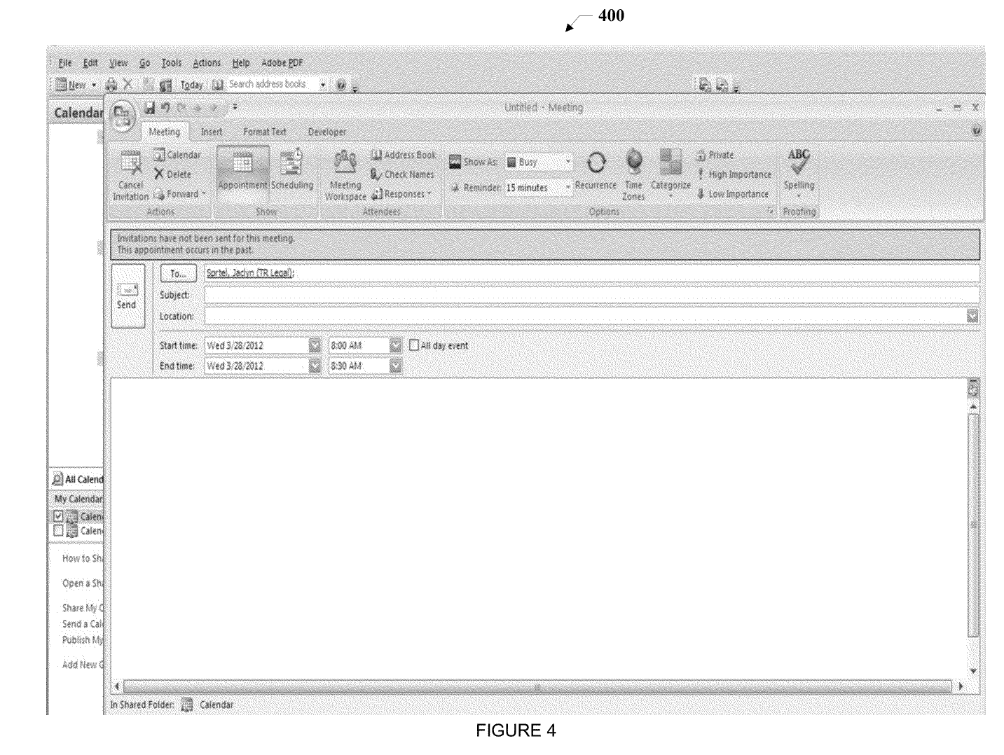

Server 120 is generally representative of one or more servers for serving data in the form of a webpage or other markup language with associated applets, ActiveX controls, and/or other related software and data structures. Server 120 includes a processor module 121 and a memory 122, wherein the memory 122 further includes lead evaluation module 140, a search module 123 and a content database 124. All of the components within server 120 are connected via computer bus 102, which is shown in various pathways. Computer buses 101, 102 and/or 103 are buses that transmit information between the access device's components/elements and/or between multiple access devices. For example, computer bus 101 and computer bus 102 aid in transmitting information (e.g., a signal) within access device 130 and server 120, respectively. Processor module 121 may use computer bus 102 to queue a request which is to be transmitted through a signal, from server 120 via a wireless or wireline transmission channel 150 and is then ultimately received by processor module 131 through the utilization of computer bus 101. Generally, server 120 transmits the signal via a wireless or wireline transmission channel 150 to at least one access device, such as access device 130. Supplementing the previous example, the signal from server 120 may be associated with a request to display an interface (See FIG. 3) on access device 130.

Processor module 121 includes one or more local and/or distributed processors, controllers and/or virtual machines. In the exemplary embodiment, processor module 121 takes any convenient and/or desirable form known to those skilled in the art. Memory 122 takes the exemplary form of one or more electronic, magnetic, and/or optical data-storage devices and stores a search module 123, a content database 124 and lead evaluation module 140.

Search module 123 includes one or more search engines and related user-interface components (not shown), for receiving and processing queries against content database 124. Content database 124 takes the exemplary form of one or more electronic, magnetic, and/or optical data-storage devices. Content database 124 may contain legal cases and/or metadata relating to the legal cases. In addition, the content database 124 may also contain public records information, U.S. Census Bureau information, demographic information, analytics and the like. This content may also be considered subscriber content. Subscriber content includes content and related data for controlling, administering, and managing pay-as-you-go and/or subscription based access. For instance, a consumer may have to subscribe to a lead evaluation service. The content is stored in the content database 124 until a set of consumer credentials is authenticated. For instance, consumer credentials may be a consumer name and associated password. Once the credentials are successfully authenticated on server 120, a signal, including the information, is transmitted over a wireless or wireline transmission channel 150 to access device 130. For purposes described herein, successfully authenticating a set of consumer credentials means the consumer credentials are accepted by an authentication system (not shown). This successful authentication allows for receiving and/or transmitting of information.

Access device 130 is generally representative of one or more access devices. In addition, access device 130 may be mobile or non-mobile. For example, a mobile and/or non-mobile access device may take the form of a personal computer, workstation, personal digital assistant, mobile telephone, smartphone, APPLE® iPad, and/or any other device capable of providing an effective consumer interface with a server and/or database. Specifically, in this exemplary embodiment, access device 130 is a mobile access device which includes a graphical interface 138, a processor module 131, a memory 132, and a keyboard 134. All of these elements are connected via computer bus 101, which is shown in various pathways throughout the access device 130.

Processor module 131 includes one or more processors, processing circuits, and/or controllers. In the exemplary embodiment, processor module 131 takes any convenient and/or desirable form known to those skilled in the art. Memory 132 is coupled, via computer bus 101, to processor module 131.

Memory 132 and hard drive (not shown) are examples of main memory and secondary memory, respectively. In this document, the terms “computer program medium,” “computer usable medium,” and “computer readable medium” may generally refer to media such as main memory, secondary memory, removable storage drive, a hard disk installed in a hard disk drive and/or other media known to those skilled in the art. The computer readable medium, for example, may include non-volatile memory, such as a floppy disk, ROM, flash memory, disk drive memory, a CD-ROM, a CD-optical drive or disc and/or other permanent storage. Additionally, a computer readable medium may include, for example, volatile storage such as RAM, buffers, cache memory, and/or network circuits. The processor module 131 reads data, instructions, messages or message packets, and other computer readable information from the computer readable medium.

In one exemplary embodiment, memory 132 stores code (machine-readable or executable instructions) for an operating system 136. Operating system 136 is coupled to a graphical interface 138 and other various components thereof, via computer bus 101. In the exemplary embodiment, operating system 136 takes the form of a version of the MICROSOFT® WINDOWS® operating system, and browser 1383 takes the form of a version of MICROSOFT® INTERNET EXPLORER®. In addition, operating system 136 interacts, via computer bus 101, with the keyboard 134 and the processor module 131. For example, the keyboard 134 sends inputs, via computer bus 101, to the operating system 136. The operating system 136 then determines the lead evaluation module 140 needs to be utilized, engages the lead evaluation module 140 through the signal via a wireless or wireline transmission channel 150, accepts the lead evaluation module output as data and stores that data temporarily in memory 132 (e.g., RAM). Operating system 136 and browser 1383 not only receive inputs from keyboard 134, but also support rendering of graphical consumer interfaces within graphical interface 138.

Graphical interface 138 includes a browser 1383 and a display 1381. When the lead evaluation module 140 is initiated, a display 1381 is defined in memory 132 and rendered on graphical interface 138. Upon rendering, the graphical interface 138 presents the data in association with a set of modules from the lead evaluation module 140 as further discussed herein.

FIG. 1A illustrates an exemplary embodiment of the lead evaluation module 140. The lead evaluation module 140 is configured to execute a set of modules from memory 122. The modules include a lead management module 140a, a case evaluator module 140b, an additional information module 140c, an analysis module 140d, a delivery module 140e and a notification module 140f. These modules may be operatively connected to each other in several configurations. One exemplary configuration along with each module is described herein.

A lead management module 140a is configured to receive a set of lead information. The set of lead information may include first name, surname, phone number, address, email address, legal case type, facts about the legal case, date of initial contact, type of initial contact, education, occupation, marital status, number of dependents, any combination thereof and the like. For example, a lead with a personal injury case (i.e., legal case type) may call a service which matches the lead to an attorney specializing in personal injury. The service may use the lead management module 140a configured to receive lead information. The lead may be asked to provide her full name, home address, primary phone number, email address, date of incident, education level, marital status, number of dependents, and additional facts relating to the case. In addition, the lead management module 140a is configured to receive the date in which the call occurred between the service and the lead and/or the type of initial contact (e.g., a phone call and/or email) from the lead. In some embodiments, the lead management module 140a is configured to manage multiple sets of lead information during the various stages of evaluating a lead. For example, the service may intake the initial information about the lead such as first name, surname, home address, phone number, type of initial contact, and legal case type. Next, the attorney may contact the lead by phone/email to gather additional information to assess the merits of the legal case. For instance, the attorney may manually populate additional information into an electronic and/or paper form for potential clients. In other embodiments, the lead management module 140a is further configured to receive a set of lead information from multiple leads where the multiple leads are from a group of attorneys within a single firm and/or multiple firms. In some embodiments, the lead management module 140a is configured to receive and store the set of information at various stages of information gathering. In other embodiments, the set or a copy of the set of lead information may be stored within content database 124. Referring back to FIG. 1A, the lead management module 140a is operatively connected to a case evaluator module 140b and an additional information module 140c.

A case evaluator module 140b is configured to generate a case evaluation. The case evaluation is an assessment of a legal case based on the set of lead information. For example, the set of lead information may include whether the lead is a plaintiff or a defendant, the state in which incident occurred, the location of incident and any other information related to the legal case. The case evaluation may include statistics and the like on the resolution of other legal cases with similar facts and/or information. For example, statistics may be provided on the average case value, the last legal case award in a geographical area, and/or percentages of plaintiff wins, defendant wins and settlement. The case evaluation allows the user to assess the quality of a lead which in turn may increase the revenue by engaging, and ultimately representing, profitable leads. An exemplary interface displaying exemplary case evaluation is illustrated in FIG. 3 and described in the corresponding Exemplary Interface section. Referring back to FIG. 1A, the case evaluator module 140b is operatively connected to an additional information module 140c, an analysis module 140d and a delivery module 140e.

An additional information module 140c is configured to retrieve a set of additional information. The set of additional information is also associated with the set of lead information. For example, the set of additional information may include an interactive map showing the location of an address, a household income value, a home value, a range within the area of any value and/or any information in which the lead did not directly provide. For example, a lead provides a home address. This home address may be used as search criteria in a property value website to determine the home value and/or a home value range for houses in that area. In addition, the set of lead information may be used to search public records content to determine if a lien is placed on any property owned by the lead. The additional information module 140c is operatively connected to a case evaluator module 140b, an analysis module 140d and a delivery module 140e.

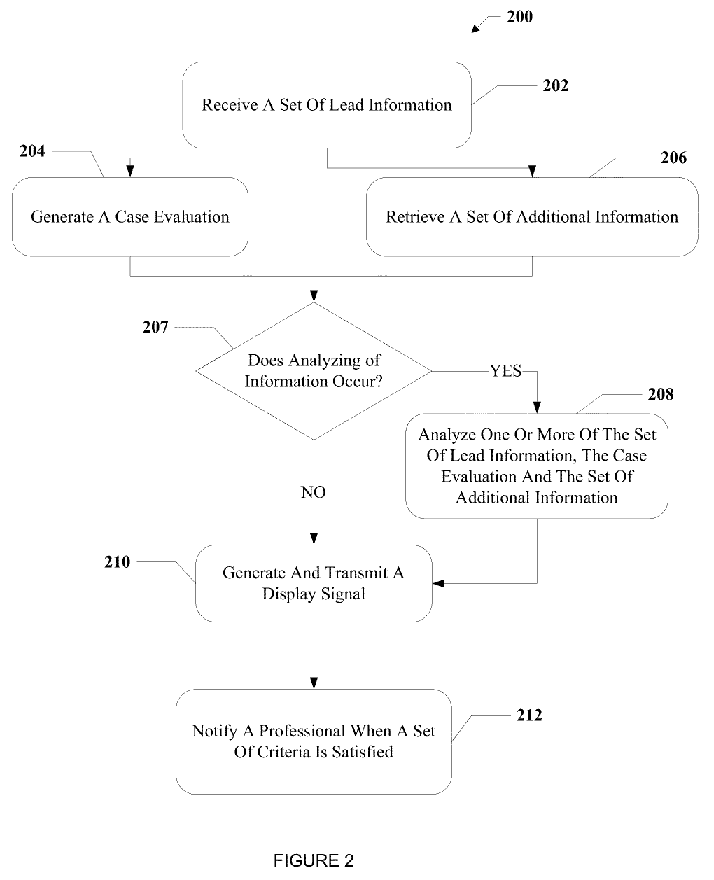

In some embodiments, an analysis module 140d is configured to analyze one or more of the set of lead information, the case evaluation and the set of additional information. Exemplary analyses may include comparative analytics, aggregation, conversion rates, market sizing and/or any other analyses which may be implemented using the above-mentioned information. See FIG. 2 and the corresponding Exemplary Method section for a further description of analyzing the set of lead information, the case evaluation and/or the set of additional information. The analysis module 140d is operatively connected to a delivery module 140e.

Whether operatively connected to the additional information module 140c, the case evaluator module 140b and/or the analysis module 140d, a delivery module 140e is configured to generate and transmit a display signal. The display signal is associated with the set of lead information, the case evaluation and the set of additional information. The display signal is generated and transmitted over transmission channel 150 to access device 130. Ultimately, the information associated with the display signal may be displayed to the user on browser 1383. See FIG. 3 and the corresponding description within the Exemplary Interface section for an example of information associated with a display signal.

In other embodiments, a notification module 140f is operatively connected to the delivery module 140e. The notification module 140f is configured to notify a professional when a set of criteria is satisfied. The set of criteria is associated with meeting or exceeding a threshold for at least one of the set of lead information, the case evaluation and the set of additional information. The notification may be initiated by a service and/or automatically. For example, an attorney informs a service that he only wants to be notified when a lead has a personal injury case type, a legal case value above $30,000 and addresses only within the state of California. This information is a set of criteria the attorney wants to be satisfied before he gets notified. If the incoming information meets or exceeds his pre-determined threshold, then he is notified by his choice of communication (e.g., email, phone, SMS messaging). Continuing from the current example, the legal case type and address may be considered lead information while the legal case value may be considered a case evaluation. In another example, if a service determines the set of criteria is satisfied, the service may notify the attorney via email and/or phone. On the other hand, an administrative assistant may be inputting a lead's information and the notification module 140f is configured to recognize the set of criteria has been satisfied and an email is automatically sent notifying the attorney of the lead. While the notifications may be tailored, the attorney may have obligations to respond to every lead even when no notifications for a given lead are received. Notifications and responding to leads are further described in the Exemplary Method section

### Exemplary Method 200 as Conducted by System 100

Referring now to FIG. 2, system 100 is configured to implement method 200, which may be adapted to incorporate the capabilities, functions, systems, and interfaces of the present invention. Method 200 includes functional blocks 202-212. These functional blocks are steps that perform actions including assignments, decisions, assessments and other like functions.

In step 202, a set of lead information is received by the lead management module 140a. This lead information may also be stored and managed in the lead management module 140a. The lead information may come from various sources. For example, a lead may fill out a form on an attorney's website. The information provided in the form is sent to and received by the lead management module 140a. In another example, a service may receive a phone call from a lead. An operator from the service may use the lead management module 140a to receive the set of lead information that he/she inputs. Once the set of lead information is received, the process may continue to step 204 or step 206, sequentially or simultaneously.

In step 204, a case evaluation is generated by the case evaluation module 140b. In order to generate a case evaluation, at least a sub-set of the set of lead information is used as a query. For example, the party type, state of incident, legal case type (e.g., a sub-set of the set of lead information) may be used as a query for the search module 123. Next, the search module 123 executes the query against content database 124. The search module 123 retrieves a set of data related to the query. The set of data may include cases and/or metadata associated with the cases. This data may then be aggregated, formatted and, ultimately, displayed to a user. An exemplary system and method for evaluating cases is described in U.S. patent application Ser. No. 12/188,117 entitled “Systems, Methods, Software And Interfaces For Reporting Results Derived From Jury Verdict Summary Content, Court Documents And Other Analytical And Litigation Materials.” This application is incorporated by reference herein. An exemplary interface displaying an exemplary case evaluation is illustrated in FIG. 3 and described in the Exemplary Interfaces section. If the process chooses step 204 initially, then the process advances to step 206. On the other hand, if the process chooses to simultaneously execute steps 204 and 206, then the process moves to step 208.

In step 206, a set of additional information is retrieved. In order to retrieve a set of additional information, at least a sub-set of the set of lead information is used as a query. For example, the address and the full name (e.g., a sub-set of the set of lead information) may be used as a query for the search module 123. Next, the search module 123 executes the query against content database 124. The search module 123 retrieves data related to the query. For instance, given the full name “Charlie Sheen” and an address that includes the city of “Beverly Hills,” the query including “Charlie Sheen and Beverly Hills” may be formed and executed against content database 124. Exemplary data may include the home value for Charlie Sheen's residence, the average household income within the area of Beverly Hills, an average education level within Beverly Hills, and an average age demographic. The data may then be aggregated, formatted and, ultimately, displayed to a user. An exemplary interface displaying exemplary additional information is illustrated in FIG. 3 and described in the Exemplary Interface section. After steps 204 and 206 have each executed, the process advances to decision box 207.

In some embodiments, one or more of the set of lead information, the case evaluation and the set of additional information may be analyzed. At decision box 207, a decision needs to be made as to whether analyzing one or more of the set of lead information, the case evaluation and the set of additional information occurs. If analyzing occurs, the process continues to step 208. If no analyzing occurs, the process then moves to step 210. Each step is discussed herein.

In step 208 the one or more of the set of lead information, the case evaluation and the set of additional information is analyzed. Various analytics may be calculated with the abovementioned information. In one example, analytics may be done to determine the conversion rate on different types of cases. A conversion rate is the ratio of visitors who convert casual content views or website visits into desired actions based on subtle or direct requests from firms, marketers, advertisers, content creators and the like. If the prospect has visited a firm's website, an example of a conversion action might include submitting an initial information form about his/her legal case. For instance, solo practioner, John Doe, is looking to expand his practice from criminal defense into estates and trusts. The lead information may be kept, aggregated and analyzed to determine the conversion rate of all the cases and/or a set of case types. In another example, the initial case evaluation may be used to compare against the actual settlement award and/or outcome. In yet another example, the duration and completeness of a case may be compared to an average duration and completeness of similar cases. The completeness of case may be an action, event and/or where the case stands within a given legal procedure. An average completeness of case takes into account all the cases for a given legal cause of action and is an action, event and/or stage of the case where the case is considered complete (i.e. settles, wins, loses, etc.). For example, if the average duration of a criminal defense case is seventeen (17) months and the average completeness of a case is attending a pre-trial hearing then an attorney may compare the average with his case and use this knowledge for future cases. In addition, additional information regarding a set of leads may be aggregated and a median calculation may occur of average income, average home value ranges, average education level and the like. Consequently, these exemplary analytics may be done to inform a practitioner's strategy regarding website search, marketing and branding. Referring back to the solo practioner example, Mr. Doe may choose to adjust his marketing strategy once he realizes, via the analytics, that the estates and trusts practice area of his firm has a steady conversion rate (e.g., an exemplary rate for determining how many leads progress into contractual clients) increase as compared to the criminal defense area. Therefore, Mr. Doe may choose to focus his search strategy, marketing and website branding in the area of estates and trusts rather than criminal defense. Additionally, an extension of the previous example may also occur. Using cases, dockets and keywords, an analysis may be done on the size of the market including a further analysis with the conversion rate of the practioner and/or firm within the market. Exemplary markets may be practice area markets including but not limited to legal, financial, tax, accounting, scientific, healthcare and the like. For example, one analytic may use cases and dockets to determine how many dockets are filed and cases are concluded each year in Dakota County, Minnesota within the estates and trusts practice area. Then, an exemplary conversion rate may be calculated to determine how many of those dockets/cases either contacted the given firm via website keyword search, phone call and/or email. Next, a comparative analysis is done to determine how much of the estates and trust practice area market the given firm is occupying. For instance, if the market shows that only five (5) dockets are filed a year on estate and trusts in Dakota County and the solo practioner has three (3) of the five (5) then the solo practitioner has 60% of the market. However, since three (3) cases may not be an optimal workload, the practitioner may choose to expand his current practices areas and/or seek additional thriving practice areas using the analytics described above. Furthermore, if the practioner has a high conversion rate for the leads that come in but the overall number of leads is low, the practioner may choose to update his search strategy within the search engine, extend his marketing to present his additional practice area and/or brand his website to promote his areas. Once step 208 completes, the process then executes step 210.

In step 210, a display signal is generated and transmitted by the delivery module 140e. The display signal is transmitted via the transmission channel 150 to access device 130. Additionally, information included in the display signal may ultimately be displayed to the user, for example, in the browser 1383. An exemplary interface displaying information included in a display signal is illustrated in FIG. 3 and described in the corresponding Exemplary Interface section.

In some embodiments, a notification step may take place. Specifically, in step 212, a professional is notified when a set of criteria is satisfied. For example, a threshold associated with additional information may be set by an attorney who only wants to see leads that have an average household income of $100,000 or greater. In the same example, the attorney may have a threshold for only cases in Waukesha County, Wisconsin. This threshold is associated with the set of lead information. In yet the same example, the attorney may also want a threshold for the case value to exceed $30,000. This threshold is associated with the case evaluation. Continuing from the previous example, if all three of the thresholds are met or exceeded, then the set of criteria is satisfied and a notification is sent to the attorney. This notification may be by email, phone, electronic communications and the like. While the attorney may customize notifications, the attorney may have obligations to respond to every lead even when no notifications for a given lead are received. For example, the attorney may receive five (5) potential leads in a day. The leads are inputted in the lead management module 140a. At some point, the notification module 140f determines that three (3) of the five (5) leads meet the attorney's criteria and consequently notifies him to personally contact the three (3) leads. The attorney may have an ethical and/or a personal obligation to respond to all leads. For instance, the attorney may choose to be notified to personally follow-up on certain leads. However, the attorney may choose to handle the remaining leads by sending a template email, via the lead management module 140a and/or the notification module 140f, stating that the attorney wishes them the best of luck in the lead's case but does not represent the lead at this time.

### Exemplary Interfaces

FIG. 3 show an exemplary interface 300 for system 100 and method 200. FIG. 3 illustrates an exemplary display 1381 associated with a browser 1383. The exemplary display 1381 has two main sections including a statistics section 310 and a leads listing section 320. The statistics section 310 contains information, some in the form of graphical representations, regarding a firm's metrics. For example, at the bottom of the statistics section 310 is a showing of total contacts and average monthly contacts including a breakdown by the type of contact (i.e., email, call and chat). In another example, a graphical depiction is shown regarding the number of contacts between the weeks of September 3^{rd} and September 24^{th}. The graph also may display the total contact numbers for each person instead of firm-wide. In addition, other graphs and/or statistics may be shown with respect to how many people are being directed to the firm's website, how many people are searching for the firm and/or case types that the firm handles, videos including the firm and advertising including the firm. The leads listing section 320 consists of a listing of leads and/or leads with their corresponding practice area, assigned attorney if applicable, the date the lead initiated contact and the type of contact (i.e., email, phone, and chat). When a user selects a lead, a series of information is further shown to the user. For example, a user has selected the “Jessica Perez” lead within the leads listing section 320 to display the following areas: a set of lead information 320a, a case evaluation 320b and a set of additional information 320c. The exemplary set of lead information 320a contains information about the lead and/or information associated with the lead. Continuing from the previous example, the set of lead information may include name, address, phone number, mobile number, email, practice area, date of initial contact, date of last contact, status, assigned attorney, notes and the like. This information may be inputted by a service personnel and/or a firm member such as an attorney and/or administrative assistant. As described earlier, the set of lead information is then used to generate a case evaluation and/or retrieve a set of additional information. Once the case evaluation is generated and/or the set of additional information is retrieved, a display signal is transmitted via a transmission channel 150 to access device 130 and information associated with the display signal may ultimately be displayed to the user.

Referring back to the example, information associated with the display signal may be the case evaluation 320b and/or the set of additional information 320c. In this exemplary interface 300, the exemplary case evaluation 320b includes information on trends including a percentage of cases settled or won by plaintiff or defendant. In addition, an average case award value and/or last award value may be displayed. Furthermore, one skilled in the art would appreciate that a user may want various levels of information regarding a given case. For example, the case evaluation 320b may also include information regarding a profile and/or information, if known, of an entity such as the judge and/or opposing counsel on the case. For instance, in third (3^{rd}) degree assault cases before Judge Smith, there may be information showing that Judge Smith orders thirty (30) days in jail and no fees over fifty percent (50%) of the time for this type of assault. As previously mentioned, U.S. patent application Ser. No. 12/188,117 entitled “Systems, Methods, Software And Interfaces For Reporting Results Derived From Jury Verdict Summary Content, Court Documents And Other Analytical And Litigation Materials” describes other exemplary embodiments for case evaluations and is herein incorporated by reference. A profile for a judge and/or opposing counsel may include current and previously held positions, the law school that was attended, the location of the law firm/court, and the like. Exemplary profiles and profile creation are described in various patents and applications including U.S. Pat. No. 7,333,966 entitled “SYSTEMS, METHODS, AND SOFTWARE FOR HYPERLINKING NAMES,” U.S. patent application Ser. No. 11/960,054 entitled “SYSTEMS, METHODS, AND SOFTWARE FOR HYPERLINKING NAMES,” and U.S. Pat. Nos. 7,571,174 and 8,001,129 each entitled “SYSTEMS, METHODS, INTERFACES AND SOFTWARE FOR AUTOMATED COLLECTION AND INTEGRATION OF ENTITY DATA INTO ONLINE DATABASES AND PROFESSIONAL DIRECTORIES.” The application and patents are herein incorporated by reference. In addition, the profile and/or statistics may not be shown directly on exemplary interface 300. Instead, a link may navigate the user to such information. The technique of using a link to navigate to information is well known to those skilled in the art. The exemplary set of additional information may include household income ranges, home value ranges, marital status, occupation, children status, and education level. While some information may have come from the lead, additional information may come from other sources before being retrieved and ultimately displayed to the user. For example, the household income range information may come from the U.S. Census Bureau. Furthermore, once the lead information has been assessed, additional embodiments may include, within the display 1381, a notification button 350. This notification button 350 may be to schedule an appointment and/or send a notification via email, phone, and/or any messaging service. In FIG. 3, the notification button 350, when selected, navigates the user to FIG. 4, an additional display screen 400, wherein the user may schedule an appointment with a specific attorney.

The embodiments described above and in the claims are intended only to illustrate and teach one or more ways of practicing or implementing the present invention, not to restrict its breadth or scope. For example, the lead evaluation module 140 may be stored elsewhere besides the memory 122. Any location within the server 120 where data might be temporarily and/or permanently stored is acceptable. In another example, information is not displayed in segregated areas such as a set of lead information 320a, a case evaluation 320b and a set of additional information 320c. The information may be more integrated into one large area containing various types of information. In another example, FIG. 1 shows browser 1383 and display 1381 as having the ability to display simultaneously. However, in operation, some embodiments may present them at separate times. The actual scope of the invention, which embraces all ways of practicing or implementing the teachings of the invention, is defined by the claims and their equivalents.

1. A lead evaluation system comprising:
a. a processor;
b. a memory coupled to the processor; and
a. a lead evaluation module stored in the memory for execution by the processor, the lead evaluation module comprising:
i. a lead management module, the lead management module configured to receive a set of lead information;
ii. a case evaluator module, the case evaluator module configured to generate a case evaluation associated with the set of lead information;
iii. an additional information module, the additional information module configured to retrieve a set of additional information associated with the set of lead information; and
iv. a delivery module, the delivery module configured to:
1. generate a display signal associated with the set of lead information, the case evaluation and the set of additional information; and
2. transmit the display signal.

2. The system of claim 1 further comprising an analysis module, the analysis module configured to analyze one or more of the set of lead information, the case evaluation and the set of additional information.

3. The system of claim 1 further comprising a notification module, the notification module configured to notify a professional when a set of criteria is satisfied, the set of criteria being associated with meeting or exceeding a threshold for at least one of the set of lead information, the case evaluation and the set of additional information.

4. The system of claim 1 wherein the set of lead information comprises one or more of a first name, a last name, a phone number, a city, a state, a legal case type, and a set of facts associated with a legal case.

5. The system of claim 1 wherein the case evaluation comprises one or more a case trend, an average case award value, a last award value, at least one entity profile and a set of information regarding an entity associated with a lead in a case.

6. The system of claim 5 wherein the at least one entity profile is a profile of a judge and the set of information regarding an entity associated with the lead in the case is the set of information regarding the judge associated with the lead in the case.

7. The system of claim 5 wherein the at least one entity profile is a profile of an opposing counsel and the set of information regarding an entity associated with the lead in the case is the set of information regarding the opposing counsel associated with the lead in the case.

8. The system of claim 1 wherein the additional information comprises one or more of a household income, a house property estimate, a set of neighborhood home values and a map of a property location.

9. A method for evaluating a lead, the method comprising:
a. receiving a set of lead information;
b. generating a case evaluation associated with the set of lead information;
c. retrieving a set of additional information associated with the set of lead information;
d. generating a display signal associated with the set of lead information, the case evaluation and the set of additional information; and
e. transmitting the display signal.

10. The method of claim 9 further comprising analyzing one or more of the set of lead information, the case evaluation and the set of additional information.

11. The method of claim 9 further comprising notifying a professional when a set of criteria is satisfied, the set of criteria being associated with meeting or exceeding a threshold for at least one of the set of lead information, the case evaluation and the set of additional information.

12. The method of claim 9 wherein the set of lead information comprises one or more of a first name, a last name, a phone number, a city, a state, a legal case type, and a set of facts associated with a legal case.

13. The method of claim 9 wherein the case evaluation comprises one or more a case trend, an average case award value, a last award value, at least one entity profile and a set of information regarding an entity associated with a lead in a case.

14. The method of claim 13 wherein the at least one entity profile is a profile of a judge and the set of information regarding an entity associated with the lead in the case is the set of information regarding the judge associated with the lead in the case.

15. The method of claim 13 wherein the at least one entity profile is a profile of an opposing counsel and the set of information regarding an entity associated with the lead in the case is the set of information regarding the opposing counsel associated with the lead in the case.

16. The method of claim 9 wherein the additional information comprises one or more of a household income, a house property estimate, a set of neighborhood home values and a map of a property location.
